(19) United States
(12) Patent Application Publication
(10) Pub. No.: US 2006/0030981 A1
(43) Pub. Date: Feb. 9, 2006

(54) Automated analysis of vehicle diagnostic data stream to identify anomaly

(75) Inventors: Michael J. Robb, San Jose, CA (US); Neil A. Davis, Stockton, CA (US); James J. Cancilla, San Jose, CA (US)

Correspondence Address: McDERMOTT, WILL & EMERY, 600 13th Street, N.W., Washington, DC, 20005-3096, US

(73) Assignee: SNAP-ON INCORPORATED

(21) Appl. No.: 10/895,825

(22) Filed: Jul. 22, 2004

(51) Int. Cl. G01M 17/00

(52) U.S. Cl. 701/29; 701/35; 701/33

(57) ABSTRACT

A vehicle diagnostic system comprising a rules storage system configured to store one or more rules, each of which determines whether the vehicle may have an anomaly when applied to vehicle diagnostic information. An operator interface may be configured to alert an operator of the diagnostic system to a suspected anomaly in the vehicle. A processing system may be configured to receive diagnostic information from the vehicle, apply one or more rules in the rules storage system to the diagnostic information, and cause the operator interface to alert the operator to a suspected anomaly in the vehicle if the application of the one or more rules results in a determination that the vehicle may have that anomaly. Variations and related processes are also disclosed.

### BACKGROUND

1. Field

This invention relates to vehicle diagnostic equipment, including scantools that analyze data streams, such as data streams that comply with the OBD II data stream specification.

2. Description of Related Art

Vehicles, such as automobiles, often include numerous on-board computer systems. Each computer system often operates and tests various aspects of the vehicle, including aspects relating to the engine, anti-lock braking system (ABS), transmission and air bag. As many as 70 separate on-board computer systems may be present.

Scantools are diagnostic devices that provide information about vehicles through interrogation of these on-board computer systems. An interrogation may seek individual sensor data, such as a throttle, RPM or coolant temperature. Another interrogation may test for the setting of codes by the vehicle, such as a code indicating that there was an emission fault. A still further interrogation may cause the vehicle to perform a particular test and to return the results of that test.

Scantools often communicate with the vehicle in accordance with an established communication specification, such as the OBD II data stream specification. The diagnostic information that is returned from the vehicle may be displayed either in text or graphic format on a display associated with the scantool.

In order to diagnose a particular problem with the vehicle, the mechanic must often determine which tests to administer and must analyze the diagnostic information that is returned as a result. Some scantools assist the mechanic by allowing the mechanic to program the scantool to begin recording diagnostic information when a particular condition is met, such as when the output of a sensor exceeds a pre-determined value.

Unfortunately, determining which tests to run and interpreting the diagnostic information that is returned as a result can require a great deal of skill and experience. This can limit the type of personnel that can effectively use these scantools or lead to errors in the assessment of anomalies in the vehicle.

### SUMMARY

A vehicle diagnostic system may include a rules storage system configured to store one or more rules. Each rule may determine whether a vehicle may have an anomaly when applied to vehicle diagnostic information. An operator interface may be configured to alert an operator of the diagnostic system to a suspected anomaly in the vehicle. A processing system may be configured to receive diagnostic information from the vehicle, apply one or more rules in the rules storage system to the diagnostic information, and cause the operator interface to alert the operator to a suspected anomaly in the vehicle if application of the one or more rules results in a determination that the vehicle may have that anomaly.

The processing system may be configured to deliver a plurality of different types of test requests to the vehicle. Each test request may cause a different type of diagnostic information to be sent by the vehicle to the diagnostic system.

The rules storage system may be configured to store a relationship between each rule and the type of diagnostic information to which the rule applies. The processing system may be configured to consult the relationships in the rules storage system for the purpose of identifying the rule or rules that should be applied to a particular type of diagnostic information and to only apply the identified rule or rules to that information.

The vehicle diagnostic system may include a test sets storage system configured to store a plurality of test sets. Each test set may designate a plurality of test requests that are to be sent to the vehicle in response to a single request for the test set.

The test sets storage system may be configured to store a relationship between each test set and a description of the test set that the operator may select for the purpose of initiating the test set. The processing system may be configured to present a plurality of the descriptions of the test sets to the operator and to implement the test set selected by the operator.

The processing system may be configured to receive diagnostic information from the vehicle in response to each test request in the selected test set; apply one or more rules in the rules storage system to the diagnostic information provided in response to each test request in the selected test set; and cause the operator interface to alert the operator to each suspected anomaly in the vehicle that application of the one or more rules determines that the vehicle may have.

The vehicle diagnostic system may include a vehicle interface configured to receive the diagnostic information from the vehicle in the form of a data stream and to deliver the diagnostic information to the processing system. The vehicle interface may be configured to receive a data stream in compliance with the OBD II data stream specification.

The operator interface may include a display.

The operator interface may be configured to display at least portions of the diagnostic information and to alert the operator to a suspected anomaly in the vehicle by giving emphasis to a displayed portion of the diagnostic information that is indicative of the suspected anomaly.

The operator interface may be configured to alert an operator by providing a description of the suspected anomaly.

The operator interface may be configured to alert an operator by suggesting one or more additional tests to run.

The rules storage system may contain rules that are not created by the operator of the vehicle diagnostic system. The rules storage system may contain rules that are created by the manufacturer of the vehicle diagnostic system.

The rules storage system may be configured to store rules that test for an out-of-bound condition, a glitch, a step function, a matching pattern, and/or a logical combination of other rules.

A vehicle diagnostic system may include a test sets storage system configured to store a plurality of test sets. Each test set may designate a plurality of test requests that are to be sent to a vehicle in response to a single request for the test requests designated by that test set. Each test request may cause a different type of diagnostic information to be sent by the vehicle to the diagnostic system. A processing system may be configured to receive an identification of a selected test set in the test sets storage system, obtain from the test sets storage system the plurality of test requests designated by the selected test set, send the plurality of test requests designated by the selected test set to the vehicle, and receive diagnostic information from the vehicle in response to each communicated test request.

A vehicle diagnostic process may include sending a test request to a vehicle; receiving diagnostic information from the vehicle in response to the test request; applying one or more rules to the diagnostic information, each rule configured to determine whether the vehicle may have an anomaly; and alerting a technician to a suspected anomaly in the vehicle if the application of one or more rules to the diagnostic information determines that the vehicle may have that anomaly.

The vehicle diagnostic process may include consulting relationships between rules and types of diagnostic information and applying only the rule or rules to the diagnostic information that have matching relationships to the type of the diagnostic information.

The vehicle diagnostic process may include sending a plurality of test requests to the vehicle in response to a technician's selection of a set of tests to run from a plurality of test sets; receiving diagnostic information from the vehicle in response to each test request; applying one or more rules to each received diagnostic information, each rule configured to determine whether the vehicle may have an anomaly; and alerting a technician to a suspected anomaly in the vehicle if the application of the one or more rules to any of the diagnostic information determines that the vehicle may have that anomaly.

The alerting may include giving emphasis to a portion of the diagnostic information that is indicative of the anomaly, providing a description of the anomaly, and/or suggesting one or more additional test to run.

One or more of the applied rules may test for an out-of bound condition, a glitch, a step function, a matching pattern and/or a logical combination of other rules.

A vehicle diagnostic process may include selecting a set of tests to run from a list of test sets; obtaining the selected set of tests to run from a test sets storage system; sending a test request for each test in the selected set of tests to a vehicle; and receiving diagnostic information in response to each test request from the vehicle.

These as well as other objects, features, benefits, components and steps will now become clear from the following detailed description of illustrative embodiments and the accompanying drawings.

### BRIEF DESCRIPTION OF DRAWINGS

FIG. 1 is a block diagram of one embodiment of a vehicle diagnostic system in communication with a vehicle.

FIG. 2 is a block diagram illustrating examples of the types of rules that may be stored in the rules storage system shown in FIG. 1.

FIG. 3 is a table illustrating one embodiment of relationships between rules and diagnostic information types that may be stored in the rules storage system shown in FIG. 1.

FIG. 4 is a table illustrating one embodiment of relationships that may be stored in the test series storage system shown in FIG. 1.

FIG. 5 is a flow diagram of one embodiment of a process that may be implemented by the vehicle diagnostic system shown in FIG. 1.

### DETAILED DESCRIPTION OF ILLUSTRATIVE EMBODIMENTS

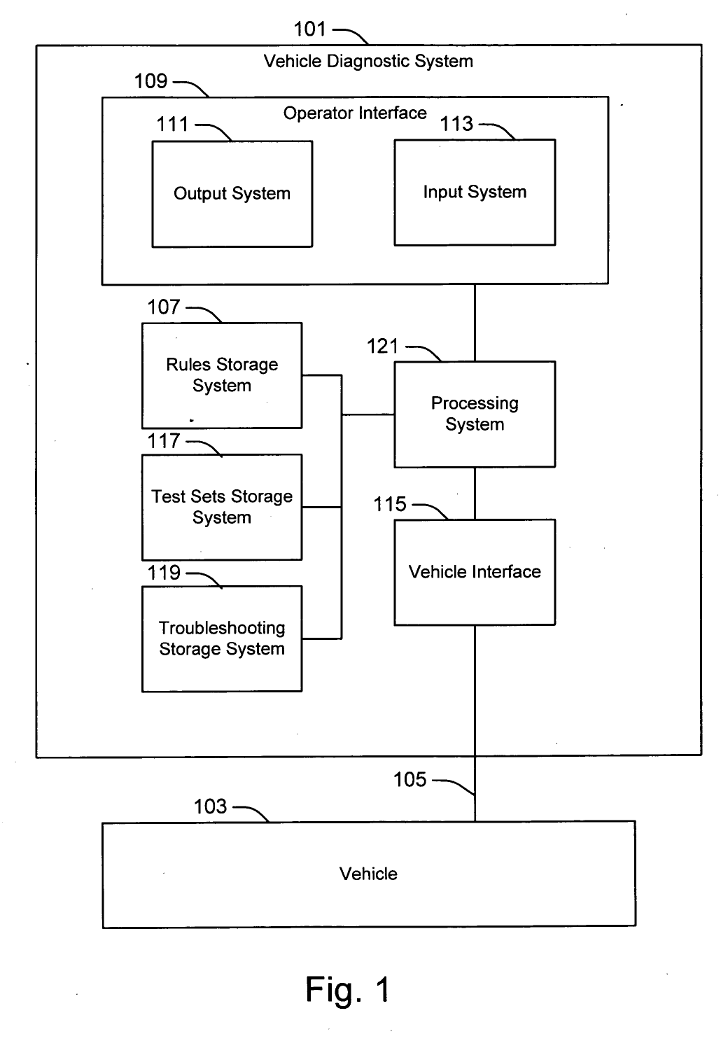

FIG. 1 is a block diagram of one embodiment of a vehicle diagnostic system in communication with a vehicle.

As shown in FIG. 1, a vehicle diagnostic system 101 is in communication with a vehicle 103 over a communication link 105.

The vehicle 103 may be any type of vehicle, including a land vehicle, such as an automobile, truck or motorcycle; a flying vehicle, such as an airplane; or a watercraft, such as a ship.

The vehicle 103 may be equipped with a diagnostic system that provides diagnostic information about the vehicle. This information may be provided in response to requests for the information. Different types of information may be returned in response to different types of requests.

Requests may be sent relating to different areas or aspects of the vehicle. When the vehicle 103 is an automobile, for example, requests may be sent relating to the engine, the anti-lock braking system (ABS), the transmission, the air bag controller and/or other systems or modules. A request may seek information about an individual sensor, such as a throttle, RPM or coolant temperature. A request may seek information about one or more codes that the vehicle has set, such as an indication that there has been an emission fault. A request may cause a test to be initiated and diagnostic information about the test to be returned.

The communication with the vehicle may take place using a data stream, such as a data stream that is in compliance with the OBD II data stream specification.

The communication link 105 may be a wired link, a wireless link, or a combination of the two. The communication link 105 may comply with the OBD II data stream specification. The communication link 105 may include one or more connectors for temporarily connecting to the diagnostic system in the vehicle 103, such as a connector in compliance with the OBD II data stream specification. The communication link 105 may include a connector to connector to a data port in the vehicle.

The vehicle diagnostic system 101 may include a rules storage system 107. The rules storage system 107 may be configured to store one or more rules. Each rule or combination of rules may determine whether a vehicle may have an anomaly when the rule is applied to diagnostic information from the vehicle.

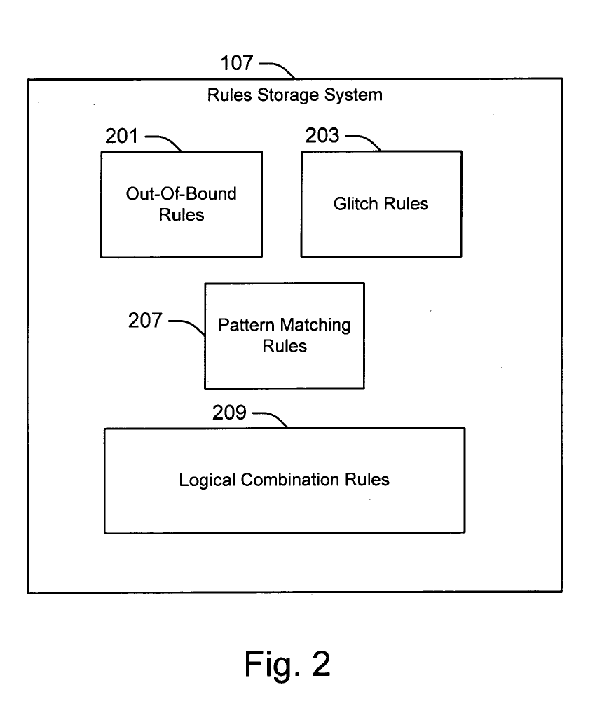

FIG. 2 is a block diagram illustrating examples of the types of rules that may be stored in the rules storage system 107 shown in FIG. 1. As shown in FIG. 2, the rules storage system 107 may include out-of-bound rules 201, glitch rules 203, step function rules 205, pattern matching rules 207 and/or logical combination rules 209.

An out-of-bound rule 201 may test certain types of diagnostic information from the vehicle to determine whether that information exceeds one or more boundaries. For example, a rule may test whether a temperature sensor is generating a signal indicating a temperature in excess of a pre-determined threshold. An out-of-bound rule may test whether diagnostic information falls within a range of values. Or within several ranges of values.

A glitch rule 203 may similarly test a particular type of diagnostic information to determine whether it evidences a problematic glitch. For example, a glitch rule may test whether a parameter has a large excursion and then returns to a base reading within a small number of sample periods of the datastream, possibly indicating an intermittent electrical contact in the sensor or controller

A pattern matching rule 207 may specify one or more patterns against which a particular type of diagnostic information is compared. A pattern matching rule 207 may include criteria that specifies the degree of similarity that is required before a match is declared.

A logical combination rule 209 may test diagnostic information against a logical combination of two or more rules. The particular rules which are the subject of a logical combination rule 209 may be one of the out-of-bound rules 201, glitch rules 203, step function rules 205 or pattern matching rules 207. It may also be another rule that is not individually accessible.

A logical combination rule 209 may be configured to operate upon a single type of diagnostic information or upon multiple types of diagnostic information, obtained either at the same or at different times.

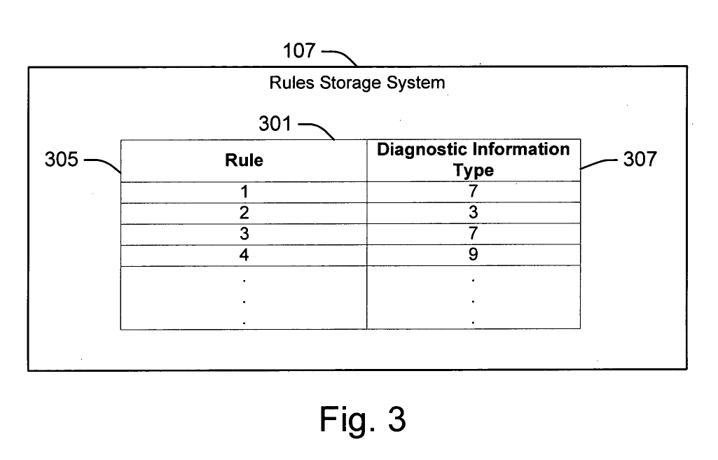

FIG. 3 is a table illustrating one embodiment of relationships between rules and diagnostic information types that may be stored in the rules storage system 107 shown in FIG. 1. As shown in FIG. 3, a rules/diagnostic information type table 301 may be included within the rules storage system 107. The table 301 may include a rule column 305 identifying each rule and a diagnostic information type column 307 identifying a type of diagnostic information to which the corresponding rule may be applied.

As illustrated in FIG. 3, rules 1 and 3, for example, may be applied to diagnostic information type 7, while rule 2 may be applied to diagnostic information type 3 and rule 4 may be applied to diagnostic information type 9. As illustrated in FIG. 3, each rule may only be applied to certain types of diagnostic information. More than one rule may be applied to a single type of diagnostic information.

Satisfaction of a rule that is stored in the rules storage system 107 may signify either an anomaly with the vehicle or that the aspect of the vehicle to which the rule has been applied is functioning properly. For example, application of an out-of-bound rule to diagnostic information may result in a determination that the diagnostic information falls within the bounds of the rule. Such an in-bounds determination may be specified to be indicative of an anomaly. It may instead be specified to be indicative of proper operation, in which event the failure of the diagnostic information to fall within the bounds might be specified as indicative of the anomaly.

One or more of the rules that are stored in the rules storage system 107 may be created by a person or group with a high degree of expertise in vehicle diagnostics. This may be a person other than the operator of the vehicle diagnostic system 101. For example, one or more of the rules may be created and/or loaded into the rules storage system 107 by the manufacturer of the vehicle diagnostic system, the distributor of the diagnostic system, the manufacturer of the vehicle, or another expert in the field.

Referring back to FIG. 1, The vehicle diagnostic system 101 may include an operator interface 109. The operator interface 109 may facilitate communications between the vehicle diagnostic system 101 and the operator of the system (not shown in FIG. 1).

The operator interface 109 may be configured to alert an operator of the diagnostic system to a suspected anomaly in the vehicle under test.

The operator interface 109 may include an output system 111 configured to communicate information from the vehicle diagnostic system 101 to the operator of it. The output system may include a display, a loudspeaker, and/or a communication link with another system.

When a display is included in the output system 111, all or a portion of the diagnostic information that is received by the vehicle diagnostic system 101 may be delivered to the display. The operator interface 109 may communicate an alert to a suspected anomaly in the vehicle to the operator by giving emphasis to a portion of the displayed diagnostic information that is indicative of the suspected anomaly. The emphasis may consist of or include flagging or tagging the portion, highlighting the portion, flashing the portion, underlining the portion, and/or application of a different color to the portion.

The operator interface 109 may also or instead alert an operator of the vehicle diagnostic system 101 to a suspected anomaly by providing a description of the suspected anomaly and/or by suggesting one or more additional tests that may be run.

The operator interface 109 may include an input system 113 through which the operator may provide information to the vehicle diagnostic system 101, such as requests that certain tests be performed. The input system 103 may include any type of input device, such as a touch screen, keyboard, mouse or communication link with another system.

The vehicle diagnostic system 101 may include a vehicle interface 115. The vehicle interface 115 may be configured to interface the information coming from the vehicle 103 over the communication link 105 to other components in the vehicle diagnostic system 101. The vehicle interface 115 may be configured to facilitate communication both from the vehicle diagnostic system 101 to the vehicle 103 and from the vehicle 103 to the vehicle diagnostic system 101. The vehicle interface 115 may be configured to manage data stream communications, including communications that are in compliance with the OBD II data stream specification.

The vehicle diagnostic system 101 may include a test sets storage system 117.

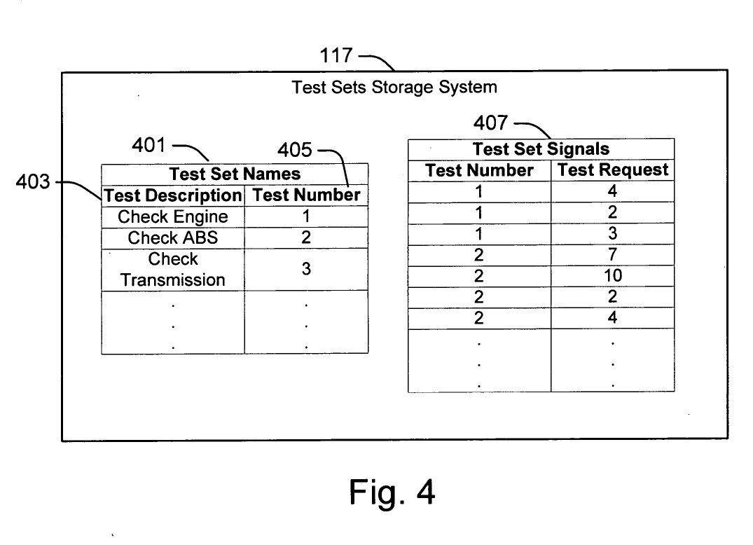

FIG. 4 is a table illustrating one embodiment of relationships that may be stored in the test sets storage system 117. As shown in FIG. 4, the test sets storage system 117 may include a test set names table 401. The test set names table 401 may include a test description 403 of sets of tests that may be performed by the vehicle diagnostic system 101 and a corresponding test number 405 for each corresponding set of tests. The test description 403 may describe the set of tests in language that is readily understood by non-expert operators. The corresponding test number 405 for each set of tests may be used as a convenience to avoid redundancy in the descriptions in a test set signals table 407.

The test set signals table 407 may include the test number 405 of each test set and a test request 407 to which each test number is associated. As can be seen from the examples in the test set signals table 407, test set number 1 has associated with it test requests 4, 2 and 3. Thus, the information stored in the test sets storage system 117 indicates that the test set described as “Check Engine” should result in the test requests 4, 2 and 3 being sent to the vehicle. Similarly, the example data in FIG. 4 indicates that the “Check ABS” test set should result in the test requests 7, 10, 2 and 4 being delivered to the vehicle.

The information shown in FIG. 4 thus illustrates that a related series of tests may be associated with a single user-friendly description. It also illustrates that the same test request, e.g., test request 2, may be a part of more than one test set group.

All or portions of the data that is stored in the test sets storage system 117 may be created by a person or group with a high degree of expertise in vehicle diagnostics. This may be a person other than the operator of the vehicle diagnostic system 101. For example, all or portions of this data may be created and/or loaded in the tests sets storage system 117 by the manufacturer of the vehicle diagnostic system 101, the distributor of the diagnostic system, the manufacturer of the vehicle, or another expert in the field.

Referring back to FIG. 1, the vehicle diagnostic system 101 may include a trouble shooting storage system 119. The trouble shooting storage system 119 may store information, such as textual material, drawings, diagrams and charts, that may be consulted by the operator of the vehicle diagnostic system 101 to assist the operator in determining what tests to run and/or in analyzing diagnostic information that is received by the vehicle diagnostic system 101.

The information in the trouble shooting storage system 119 may be created by a person or group with a high degree of expertise in vehicle diagnostics. This may be a person other than the operator of the vehicle diagnostic system 101. For example, all or portions of this information may be created and/or loaded in the trouble shooting storage system 119 by the manufacturer of the vehicle diagnostic system, the distributor of the diagnostic system, the manufacturer of the vehicle, or another expert in the field.

One or more rules in the rules storage system 107 may direct the operator to one or more sections in the trouble shooting storage system 119. One or more sections in the trouble shooting storage system 119 may, in turn, direct the operator to one or more tests or one or more test sets in the test sets storage system 117.

The vehicle diagnostic system 101 may also include a processing system 121. The processing system 121 may be any type of processing system and may include hardware and/or software. It may include one or more microprocessors, storage devices and/or memories. It may include a general purpose computer programmed to operate in connection with the vehicle diagnostic system 101 or a computing system dedicated to the vehicle diagnostic system 101. It may be a stand-alone system or part of a network. It may be in a single location or distributed across several locations.

The processing system 121 may coordinate and manage the operations of the vehicle diagnostic system 101 and the communication between its various components.

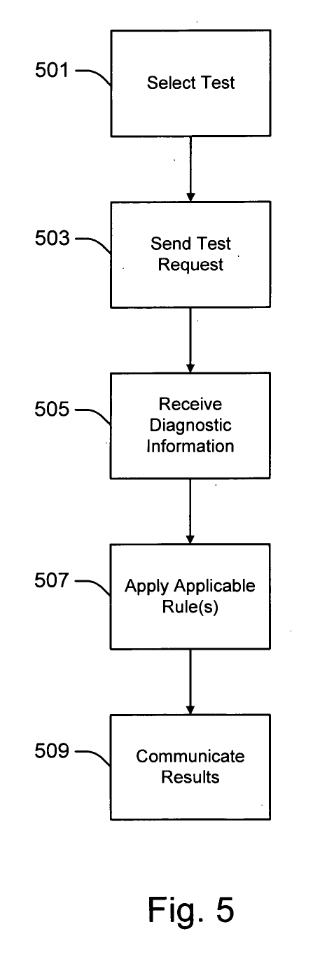

FIG. 5 is a flow diagram of one embodiment of a process that may be implemented by the vehicle diagnostic system 101 shown in FIG. 1. As shown in FIG. 5, a test to be performed by the vehicle diagnostic system 101 may be selected, as reflected by a Select Test block 501.

Any approach may be used for the Select Test block 501. For example, the operator may select the test from a list of tests that are displayed on the output system 111 under the control of the processing system 121. Alternatively, the test may be one of the tests that are provided in a test set that is stored in the test sets storage system 117. The operator may select this test set from a list of test sets that are displayed on the output system 111 under the control of the processing system 121. The selected test may be a test that is recommended by a rule that is stored in the rules storage system 107 based on an analysis of earlier diagnostic information. The selected test may be a test that is recommended by the trouble shooting storage system 119. It may be initiated automatically or through a selection made by an operator of the system. The selected test may be initiated automatically by the vehicle diagnostic system 101 as part of a comprehensive test process that the vehicle diagnostic system 101 performs on the vehicle without the operator identifying the test or tests sets to be run.

The test request that corresponds to the test may then be directed by the processing system 121 through the vehicle interface 115 into the communication link 105 and, in turn, into the vehicle 103. This is reflected in FIG. 5 by a Send Test request block 503. In an alternate embodiment, diagnostic information may be sent by the vehicle and analyzed by the vehicle diagnostic system 101 without a test request.

The diagnostic information that the vehicle 103 generates in response may be received by the processing system 121 through the vehicle interface 115 and the communication link 105, as reflected by a Receive Diagnostic Information block 505.

The processing system 121 may then apply one or more rules in the rules storage system 107 to the received diagnostic information, as reflected by an Apply Applicable Rule(s) block 507. To accomplish this, the processing system may consult the rules storage system 107 to identify the rule or rules that are specified in the rules storage system 107 to be applied to diagnostic information of the type that has been received. If the rules storage system 107 designates multiple rules to be applied, the processing system 121 may cause each of those multiple rules to be applied.

The processing system 121 may then cause the output system 111 to communicate the results of the application of the rules, as reflected in a Communicate Results block 509. The results may be any of the types of anomaly alerts that are discussed above or an affirmative communication that no anomaly has been detected at this point in the process.

The process illustrated in FIG. 5 may be repeated in connection with other desired tests. One or more of these subsequent tests may be selected and initiated by the operator. They may instead be the remaining tests in a test set that the operator previously selected from the test sets storage system 117 that have not yet been performed. In this later case, the remaining tests may be initiated automatically by the vehicle diagnostic system 101.

In the event that a test set from the test sets storage system 117 has not yet been completed, the processing system 121 may defer the reporting of any test results to the operator until all of the tests in the test set are performed and analyzed by the rules in the rules storage system 107. In this embodiment, rules may be included in the rules storage system 107 that analyze the results of multiple tests within one or more of the test sets in the test sets storage system 117. The processing may be configured to provide a consolidated report of all of the test results.

The rules storage system 107, the test sets storage system 117 and the trouble shooting storage system 119 may include any type of hardware or software arrangement. Each may include one or more disk drives, CD-ROMs, tapes, ROMs, programmable memories and/or RAMs. Components in these storage systems may be separate from or shared by the processing system 121.

Any type of logical configuration may be used for the rules storage system 107, the test sets storage system 117 and the trouble shooting storage system 119. This includes databases, such as flat databases, relational databases and/or hierarchical databases. It also includes databases that are centralized or distributed.

The foregoing description has been presented for the purpose of illustration only. It is not intended to be exhaustive or to limit the concepts that have been disclosed. Numerous modifications and variations are possible.

For example, the embodiments that have been described may include or be utilized with any appropriate voltage source, such as a battery, an alternator and the like, providing any appropriate voltage, such as about 12 volts, about 42 volts and the like.

The embodiments that have been described may be used with any desired system or engine. These systems or engines may use fossil fuels, such as gasoline, natural gas, propane and the like, electricity, such as that generated by a battery, magneto, solar cell and the like, wind and hybrids or combinations thereof. These systems or engines may be incorporated into other systems, such as an automobile, a truck, a boat or ship, a motorcycle, a generator, an airplane and the like.

In short, the scope of this application is limited solely to the claims that now follow.

We claim:

1. A vehicle diagnostic system comprising:
a rules storage system configured to store one or more rules, each of which determines whether a vehicle may have an anomaly when applied to vehicle diagnostic information;
an operator interface configured to alert an operator of the diagnostic system to a suspected anomaly in the vehicle; and
a processing system configured to:
receive diagnostic information from the vehicle;
apply one or more rules in the rules storage system to the diagnostic information; and
cause the operator interface to alert the operator to a suspected anomaly in the vehicle if application of the one or more rules results in a determination that the vehicle may have that anomaly.

2. The vehicle diagnostic system of claim 1 wherein the processing system is configured to deliver a plurality of different types of test requests to the vehicle, each one of which causes a different type of diagnostic information to be sent by the vehicle to the diagnostic system.

3. The vehicle diagnostic system of claim 2 wherein:
the rules storage system is configured to store a relationship between each rule and the type of diagnostic information to which the rule applies; and
the processing system is configured to:
consult the relationships in the rules storage system for the purpose of identifying the rule or rules that should be applied to a particular type of diagnostic information; and
to only apply the identified rule or rules to that information.

4. The vehicle diagnostic system of claim 2 further including a test sets storage system configured to store a plurality test sets, each test set designating a plurality of test requests that are to be sent to the vehicle in response to a single request for the test requests designated by that that test set.

5. The vehicle diagnostic system of claim 4 wherein:
the test sets storage system is configured to store a relationship between each test set and a description of the test set that the operator may select for the purpose of initiating the test set; and
the processing system is configured to:
present a plurality of the descriptions of the test sets to the operator; and
to implement the test set selected by the operator.

6. The vehicle diagnostic system of claim 4 wherein the processing system is configured to:
receive diagnostic information from the vehicle in response to each test request in the selected test set;
apply one or more rules in the rules storage system to the diagnostic information provided in response to each test request in the selected test set; and
cause the operator interface to alert the operator to each suspected anomaly in the vehicle that application of the one or more rules determine that the vehicle may have.

7. The vehicle diagnostic system of claim 1 further including a vehicle interface configured to:
receive the diagnostic information from the vehicle in the form of a data stream; and
deliver the diagnostic information to the processing system.

8. The vehicle diagnostic system of claim 7 wherein the vehicle interface is configured to receive a data stream in compliance with the OBD II data stream specification.

9. The vehicle diagnostic system of claim 1 wherein the operator interface includes a display.

10. The vehicle diagnostic system of claim 9 wherein the operator interface is configured to:
display at least portions of the diagnostic information; and
alert the operator to a suspected anomaly in the vehicle by giving emphasis to a displayed portion of the diagnostic information that is indicative of the suspected anomaly.

11. The vehicle diagnostic system of claim 1 wherein the operator interface is configured to alert an operator by providing a description of the suspected anomaly.

12. The vehicle diagnostic system of claim 1 wherein the operator interface is configured to alert an operator by suggesting one or more additional tests to run.

13. The vehicle diagnostic system of claim 1 wherein the rules storage system contains rules that are not created by the operator of the vehicle diagnostic system.

14. The vehicle diagnostic system of claim 13 wherein the rules storage system contains rules that are created by the manufacturer of the vehicle diagnostic system.

15. The vehicle diagnostic system of claim 1 wherein the rules storage system is configured to store rules that test for an out-of-bound condition.

16. The vehicle diagnostic system of claim 1 wherein the rules storage system is configured to store rules that test for a glitch.

17. The vehicle diagnostic system of claim 1 wherein the rules storage system is configured to store rules that test for a step function.

18. The vehicle diagnostic system of claim 1 wherein the rules storage system is configured to store rules that test for a matching pattern.

19. The vehicle diagnostic system of claim 1 wherein the rules storage system is configured to store rules that test for a logical combination of other rules.

20. A vehicle diagnostic system comprising:
a test sets storage system configured to store a plurality test sets, each test set designating a plurality of test requests that are to be sent to a vehicle in response to a single request for the test requests designated by that that test set, each test request causing a different type of diagnostic information to be sent by the vehicle to the diagnostic system; and
a processing system configured to:
receive an identification of a selected test set in the test sets storage system;
obtain from the test sets storage system the plurality of test requests designated by the selected test set;
send the plurality of test requests designated by the selected test set to the vehicle; and
receive diagnostic information from the vehicle in response to each communicated test request.

21. A vehicle diagnostic process comprising:
sending a test request to a vehicle;
receiving diagnostic information from the vehicle in response to the test request;
applying one or more rules to the diagnostic information, each rule configured to determine whether the vehicle may have an anomaly; and
alerting a technician to a suspected anomaly in the vehicle if the application of one or more rules to the diagnostic information determines that the vehicle may have that anomaly.

22. The vehicle diagnostic process of claim 21 further including:
consulting relationships between rules and types of diagnostic information; and
applying only the rule or rules to the diagnostic information that have matching relationships to the type of the diagnostic information.

23. The vehicle diagnostic process of claim 21 further comprising:
sending a plurality of test requests to the vehicle in response to a technician's selection of a set of tests to run from a plurality of test sets;
receiving diagnostic information from the vehicle in response to each test request;
applying one or more rules to each received diagnostic information, each rule configured to determine whether the vehicle may have an anomaly; and
alerting a technician to a suspected anomaly in the vehicle if the application of one or more rules to any of the diagnostic information determines that the vehicle may have that anomaly.

24. The vehicle diagnostic process of claim 21 wherein the alerting includes giving emphasis to a portion of the diagnostic information that is indicative of the anomaly.

25. The vehicle diagnostic process of claim 21 wherein the alerting includes providing a description of the anomaly.

26. The vehicle diagnostic process of claim 21 wherein the alerting includes suggesting one or more additional test to run.

27. The vehicle diagnostic process of claim 21 wherein one or more of the applied rules tests for an out-of bound condition.

28. The vehicle diagnostic process of claim 21 wherein one or more of the applied rules tests for a glitch.

29. The vehicle diagnostic process of claim 21 wherein one or more of the applied rules tests for a step function.

30. The vehicle diagnostic process of claim 21 wherein one or more of the applied rules tests for a matching pattern.

31. The vehicle diagnostic process of claim 21 wherein one or more of the applied rules tests for a logical combination of other rules.

32. A vehicle diagnostic process comprising:
selecting a set of tests to run from a list of test sets;
obtaining the selected set of tests to run from a test sets storage system;
sending a test request for each test in the selected set of tests to a vehicle; and
receiving diagnostic information in response to each test request from the vehicle.
